(19) United States
(12) Patent Application Publication
(10) Pub. No.: US 2023/0342550 A1
(43) Pub. Date: Oct. 26, 2023

(54) DEGREE OF DIFFICULTY ESTIMATING DEVICE, AND DEGREE OF DIFFICULTY ESTIMATING MODEL LEARNING DEVICE, METHOD, AND PROGRAM

(71) Applicant: NIPPON TELEGRAPH AND TELEPHONE CORPORATION, Tokyo (JP)

(72) Inventors: Sanae FUJITA, Tokyo (JP); Takashi HATTORI, Tokyo (JP); Tessei KOBAYASHI, Tokyo (JP); Yuko OKUMURA, Tokyo (JP)

(73) Assignee: NIPPON TELEGRAPH AND TELEPHONE CORPORATION, Tokyo (JP)

(21) Appl. No.: 15/734,540

(22) PCT Filed: Jun. 3, 2019
(86) PCT No.: PCT/JP2019/022053

§ 371 Date: Jun. 16, 2021

(30) Foreign Application Priority Data
Jun. 6, 2018 (JP) 2018-108551

(51) Int. Cl. G06F 40/279

(52) U.S. Cl. CPC G06F 40/279

(57) ABSTRACT

To enable difficulty or a target period of a text to be estimated with high accuracy at desired granularity. A feature amount extracting unit 230 extracts a feature amount including an acquisition period of a word from a text of a picture book, and a difficulty estimating unit 232 estimates difficulty based on the feature amount extracted with respect to the text of the picture book and on a difficulty estimation model having been learned in advance.

### TECHNICAL FIELD

The present invention relates to a difficulty estimation device, a difficulty estimation model learning device, a method, and a program, and particularly relates to a difficulty estimation device, a method, and a program for estimating difficulty of a text.

### BACKGROUND ART

Conventionally, a difficulty estimation device is known which estimates difficulty of a picture book using, as a feature amount, a ratio of hiragana or katakana, an average value of the number of characters included in one sentence, an average value of the number of clauses included in one sentence, an average value of the number of predicates included in one sentence, or the like (PTL 1).

### CITATION LIST

### Patent Literature

[PTL 1] Japanese Patent Application Laid-open No. 2016-152032

### SUMMARY OF THE INVENTION

### Technical Problem

Infants grow very quickly and changes are significant even when comparisons are made in units of age in days, age in weeks, or age in months. However, with the difficulty estimation device described in PTL 1 above, granularity of estimation that can be set with respect to difficulty is coarse such as 1 year of age. It is required that difficulty be set at finer granularity and with higher accuracy.

The present invention has been made in order to solve the problem described above and an object thereof is to provide a difficulty estimation device, a method, and a program capable of estimating difficulty or a target period of a text with high accuracy at desired granularity.

Another object of the present invention is to provide a difficulty estimation model learning device, a method, and a program capable of learning a difficulty estimation model for estimating difficulty or a target period of a text with high accuracy at desired granularity.

### Means for Solving the Problem

In order to achieve the object described above, a difficulty estimation device according to a first invention is configured to include: a feature amount extracting unit which extracts, using an acquisition period which is obtained in advance for each word and in which an infant acquires the word, a feature amount including an acquisition period of a word included in an input text from the text; and a difficulty estimating unit which estimates difficulty or a target period of the text based on the feature amount of the text, extracted by the feature amount extracting unit, and a difficulty estimation model obtained in advance for estimating difficulty or a target period of the text.

A difficulty estimation device according to a second invention is configured to include: a feature amount extracting unit which extracts, using familiarity or imageability of each word which is obtained in advance for each word, a feature amount including familiarity of a word included in an input text from the text; and a difficulty estimating unit which estimates difficulty or a target period of the text based on the feature amount of the text, extracted by the feature amount extracting unit, and a difficulty estimation model obtained in advance for estimating difficulty or a target period of the text.

A difficulty estimation device according to a third invention is configured to include: a feature amount extracting unit which extracts, from an input text, a feature amount that includes at least one of the number of arguments of a declinable word and a type of a declinable word that is included in the text; and a difficulty estimating unit which estimates difficulty or a target period of the text based on the feature amount of the text, extracted by the feature amount extracting unit, and a difficulty estimation model obtained in advance for estimating difficulty or a target period of the text.

A difficulty estimation device according to a fourth invention is configured to include: a feature amount extracting unit which extracts, for each category related to words, a feature amount that includes a ratio of nouns and/or declinable words which belong to the category and which are included in an input text from the text; and a difficulty estimating unit which estimates difficulty or a target period of the text based on the feature amount of the text, extracted by the feature amount extracting unit, and a difficulty estimation model obtained in advance for estimating difficulty or a target period of the text.

A difficulty estimation device according to a fifth invention is configured to include: a feature amount extracting unit which extracts from an input text, using one or more types of basic word sets obtained in advance, with respect to each of the one or more types of basic word sets, a feature amount including a ratio of words included in the basic word set and/or a ratio of words not included in the basic word set among words included in the text; and a difficulty estimating unit which estimates difficulty or a target period of the text based on the feature amount of the text, extracted by the feature amount extracting unit, and a difficulty estimation model obtained in advance for estimating difficulty or a target period of the text.

A difficulty estimation method according to a sixth invention includes: a feature amount extracting unit extracting, using an acquisition period which is obtained in advance for each word and in which an infant acquires the word, a feature amount including an acquisition period of a word included in an input text from the text; and a difficulty estimating unit estimating difficulty or a target period of the text based on the feature amount of the text, extracted by the feature amount extracting unit, and a difficulty estimation model obtained in advance for estimating difficulty or a target period of the text.

A difficulty estimation method according to a seventh invention includes: a feature amount extracting unit extracting, using familiarity or imageability of each word which is obtained in advance for each word, a feature amount including familiarity of a word included in an input text from the text; and a difficulty estimating unit estimating difficulty or a target period of the text based on the feature amount of the text, extracted by the feature amount extracting unit, and a difficulty estimation model obtained in advance for estimating difficulty or a target period of the text.

A difficulty estimation method according to an eighth invention includes: a feature amount extracting unit extracting, from an input text, a feature amount that includes at least one of the number of arguments of a declinable word and a type of a declinable word that is included in the text; and a difficulty estimating unit estimating difficulty or a target period of the text based on the feature amount of the text, extracted by the feature amount extracting unit, and a difficulty estimation model obtained in advance for estimating difficulty or a target period of the text.

A difficulty estimation method according to a ninth invention includes: a feature amount extracting unit extracting, for each category related to words, a feature amount that includes a ratio of nouns and/or declinable words which belong to the category and which are included in an input text from the text; and a difficulty estimating unit estimating difficulty or a target period of the text based on the feature amount of the text, extracted by the feature amount extracting unit, and a difficulty estimation model obtained in advance for estimating difficulty or a target period of the text.

A difficulty estimation method according to a tenth invention includes: a feature amount extracting unit extracting from an input text, using one or more types of basic word sets obtained in advance, with respect to each of the one or more types of basic word sets, a feature amount including a ratio of words included in the basic word set and/or a ratio of words not included in the basic word set among words included in the text; and a difficulty estimating unit estimating difficulty or a target period of the text based on the feature amount of the text, extracted by the feature amount extracting unit, and a difficulty estimation model obtained in advance for estimating difficulty or a target period of the text.

A difficulty estimation model learning device according to an eleventh invention is configured to include: a feature amount extracting unit which extracts, using an acquisition period which is obtained in advance for each word and in which an infant acquires the word, a feature amount including an acquisition period of a word included in each of texts to which difficulty or a target period has been added from the text; and a difficulty estimation model generating unit which learns a difficulty estimation model for estimating difficulty or a target period of the text based on the feature amount extracted with respect to each of the texts by the feature amount extracting unit and the difficulty or the target period added to each of the texts.

A difficulty estimation model learning device according to a twelfth invention is configured to include: a feature amount extracting unit which extracts, using familiarity or imageability of each word which is obtained in advance for each word, a feature amount including familiarity of a word included in each of texts to which difficulty or a target period has been added from the text; and a difficulty estimation model generating unit which learns a difficulty estimation model for estimating difficulty or a target period of the text based on the feature amount extracted with respect to each of the texts by the feature amount extracting unit and the difficulty or the target period added to each of the texts.

A difficulty estimation model learning device according to a thirteenth invention is configured to include: a feature amount extracting unit which extracts, from each of texts to which difficulty or a target period has been added, a feature amount that includes at least one of the number of arguments of a declinable word and a type of a declinable word that is included in the text; and a difficulty estimation model generating unit which learns a difficulty estimation model for estimating difficulty or a target period of the text based on the feature amount extracted with respect to each of the texts by the feature amount extracting unit and the difficulty or the target period added to each of the texts.

A difficulty estimation model learning device according to a fourteenth invention is configured to include: a feature amount extracting unit which extracts, for each category related to words, a feature amount that includes a ratio of nouns and/or declinable words which belong to the category and which are included in each of texts to which difficulty or a target period has been added from the text; and a difficulty estimation model generating unit which learns a difficulty estimation model for estimating difficulty or a target period of the text based on the feature amount extracted with respect to each of the texts by the feature amount extracting unit and the difficulty or the target period added to each of the texts.

A difficulty estimation model learning device according to a fifteenth invention is configured to include: a feature amount extracting unit which extracts from each of texts to which difficulty or a target period has been added, using one or more types of basic word sets obtained in advance, with respect to each of the one or more types of basic word sets, a feature amount including a ratio of words included in the basic word set and/or a ratio of words not included in the basic word set among words included in the text; and a difficulty estimation model generating unit which learns a difficulty estimation model for estimating difficulty or a target period of the text based on the feature amount extracted with respect to each of the texts by the feature amount extracting unit and the difficulty or the target period added to each of the texts.

A difficulty estimation model learning method according to a sixteenth invention includes: a feature amount extracting unit extracting, using an acquisition period which is obtained in advance for each word and in which an infant acquires the word, a feature amount including an acquisition period of a word included in each of texts to which difficulty or a target period has been added from the text; and a difficulty estimation model generating unit learning a difficulty estimation model for estimating difficulty or a target period of the text based on the feature amount extracted with respect to each of the texts by the feature amount extracting unit and the difficulty or the target period added to each of the texts.

A difficulty estimation model learning method according to a seventeenth invention includes: a feature amount extracting unit extracting, using familiarity or imageability of each word which is obtained in advance for each word, a feature amount including familiarity of a word included in each of texts to which difficulty or a target period has been added from the text; and a difficulty estimation model generating unit learning a difficulty estimation model for estimating difficulty or a target period of the text based on the feature amount extracted with respect to each of the texts by the feature amount extracting unit and the difficulty or the target period added to each of the texts.

A difficulty estimation model learning method according to an eighteenth invention includes: a feature amount extracting unit extracting, from each of texts to which difficulty or a target period has been added, a feature amount that includes at least one of the number of arguments of a declinable word and a type of a declinable word that is included in the text; and a difficulty estimation model generating unit learning a difficulty estimation model for estimating difficulty or a target period of the text based on the feature amount extracted with respect to each of the texts by the feature amount extracting unit and the difficulty or the target period added to each of the texts.

A difficulty estimation model learning method according to a nineteenth invention includes: a feature amount extracting unit extracting, for each category related to words, a feature amount that includes a ratio of nouns and/or declinable words which belong to the category and which are included in each of texts to which difficulty or a target period has been added from the text; and a difficulty estimation model generating unit learning a difficulty estimation model for estimating difficulty or a target period of the text based on the feature amount extracted with respect to each of the texts by the feature amount extracting unit and the difficulty or the target period added to each of the texts.

A difficulty estimation model learning method according to a twentieth invention includes: a feature amount extracting unit extracting from each of texts to which difficulty or a target period has been added, using one or more types of basic word sets obtained in advance, with respect to each of the one or more types of basic word sets, a feature amount including a ratio of words included in the basic word set and/or a ratio of words not included in the basic word set among words included in the text; and a difficulty estimation model generating unit learning a difficulty estimation model for estimating difficulty or a target period of the text based on the feature amount extracted with respect to each of the texts by the feature amount extracting unit and the difficulty or the target period added to each of the texts.

A program according to a twenty-first invention is a program for causing a computer to function as each unit of the difficulty estimation device according to the inventions described above.

### Effects of the Invention

With the difficulty estimation device, the method, and the program according to the present invention, by extracting, from an input text, a feature amount that includes an acquisition period of a word included in the text, familiarity or imageability of a word included in the text, at least one of the number of arguments of a declinable word and a type of a declinable word that is included in the text, for each category related to words, a ratio of nouns and/or declinable words which belong to the category, or with respect to one or more types of basic word sets, a ratio of words included in the basic word set and/or a ratio of words not included in the basic word set among words included in the text, an effect of enabling difficulty or a target period of the text to be estimated with high accuracy at desired granularity is produced.

In addition, with the difficulty estimation model learning device, the method, and the program according to the present invention, by extracting, from a text to which difficulty or a target period has been added, a feature amount that includes an acquisition period of a word included in the text, familiarity or imageability of a word included in the text, at least one of the number of arguments of a declinable word and a type of a declinable word that is included in the text, for each category related to words, a ratio of nouns and/or declinable words which belong to the category, or with respect to one or more types of basic word sets, a ratio of words included in the basic word set and/or a ratio of words not included in the basic word set among words included in the text, an effect of enabling a difficulty estimation model for estimating difficulty or a target period of the text with high accuracy at desired granularity to be learned is produced.

### BRIEF DESCRIPTION OF DRAWINGS

FIG. 1 is a block diagram showing a configuration of a difficulty estimation model learning device according to an embodiment of the present invention.

FIG. 2 is a diagram showing an example of classifications of GoiTaikei – A Japanese Lexicon.

FIG. 3 is a block diagram showing a configuration of a difficulty estimation device according to the embodiment of the present invention.

FIG. 4 is a flow chart showing a difficulty estimation model learning processing routine in the difficulty estimation model learning device according to the embodiment of the present invention.

FIG. 5 is a flow chart showing a difficulty estimation processing routine in the difficulty estimation device according to the embodiment of the present invention.

### DESCRIPTION OF EMBODIMENT

Hereinafter, an embodiment of the present invention will be described in detail with reference to the drawings. While a case where the present invention is applied to a device that estimates difficulty of a text in a picture book will be described as an example in the present embodiment, an object of the present invention is not limited to a picture book and may be a book, text data, or the like.

### Configuration of Difficulty Estimation Model Learning Device According to Embodiment of Present Invention

A configuration of a difficulty estimation model learning device according to the embodiment of the present invention will be described.

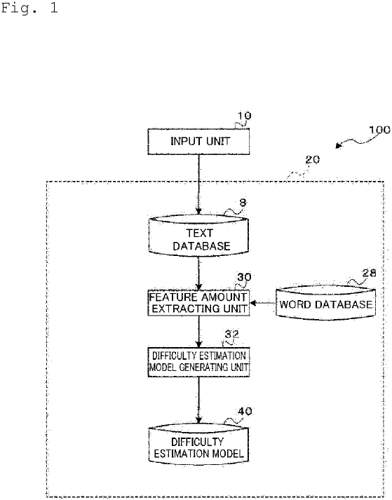

As shown in FIG. 1, a difficulty estimation model learning device 100 according to the embodiment of the present invention can be constructed by a computer that includes a CPU, a RAM, and a ROM storing a program and various types of data for executing a difficulty estimation model learning processing routine to be described later. From a functional perspective, as shown in FIG. 1, the difficulty estimation model learning device 100 is equipped with an input unit 10 and a computing unit 20.

The input unit 10 accepts, as input, each text of a picture book to which difficulty and an analysis result have been added.

The computing unit 20 is configured to include a text database 8, a word database 28, a feature amount extracting unit 30, a difficulty estimation model generating unit 32, and a difficulty estimation model 40.

The text database 8 stores texts of a picture book to which difficulty and an analysis result have been added and which have been accepted by the input unit 10. A text of the picture book represents a conversion of characters in the picture book into text data and is stored in the text database 8 as a file containing information such as line breaks, blanks, and page breaks in the text, a name of an author, a name of a publisher, and a target age. It should be noted that, in the present embodiment, the picture books stored in the text database 8 are not limited to those recommended for ages 0 to 5 and may be any book intended for children which complies with a “one book one story” format and which includes a description of difficulty (or a target period). In addition, the text need not represent an entirety of a single picture book and may represent a part of the picture book, in which case a target period in the partial text can be estimated. Furthermore, the file containing information on the picture book may be in any format such as XML, SQL, or text as long as the format enables the file to be read.

In addition, an analysis result added to the text of a picture book represents a result of an ordinary morphological analysis performed through an existing analyzer. Furthermore, a result of performing dependency parsing or an item structure analysis may be added to the text of a picture book in addition to a result of performing morphological analysis. Moreover, while there may be case where words such as “nouns”, “onomatopoeia”, “mimetic words”, and “interjections” are simply arranged in illustrated reference books and picture books intended for infants, in such a case, a morphological analysis itself need not be performed. In this case, a line break and a blank may be considered separators between words.

The word database 28 stores a child vocabulary development database (CVD) storing an acquisition period of each word, familiarity of each word, the number of arguments that each declinable word may potentially take, a frequency of appearance of each word, and a plurality of types of basic word sets.

A description of the child vocabulary development database (CVD) will now be provided. Conventionally, studies have been conducted in order to investigate what kind of words is difficult for infants to acquire. Examples of an indicator of difficulty include an acquisition period of a word. NPL 1 presents results of a study on language acquisition periods (acquisition age in days) of infants with respect to 2,700 words, and a CVD is constructed based on the study. The study was conducted in a globally unprecedented scale as a study on the acquisition periods of words by infants.

[NPL 1] Tessei Kobayashi, Yuko Okumura, Yasuhiro Minami “Collecting Data on Child Vocabulary Development by Vocabulary-Checklist Application”, IEICE Technical Report, vol. 115, no. 418, HCS2015-59, pp. 1-6, 2016.

The CVD presented in NPL 1 described above is a database that compiles information gathered by asking approximately 1,300 parents of infants (children) ranging from ages 0 to around 4 to respond, in a checklist format, to questions about whether or not their own child understands a certain word and is capable of uttering the word at the time of study, and is a collection of approximately 2,700 words. In other words, the CVD is a database of approximately 1,300 people worth of 2,700 words and an acquisition period (a comprehension period or a production period) of the 2,700 words.

The present study uses an age in days (hereinafter, referred to as 50% acquisition age in days) at which 50% of children who are objects of the study became capable of making utterances which is estimated using data obtained from the children. In this case, an age in days at which the ability to make an utterance is used instead of an age in days at which comprehension is gained because whether or not an utterance is made is more readily assessed by a parent and is therefore more reliable.

As a value of the CVD, one of or both of production days and comprehension days may be used. Alternatively, instead of an age in days, a conversion into an age in weeks, an age in months, or an age in years may be used.

The familiarity of a word is obtained in advance with respect to each word by quantifying how familiar each word is in a similar manner to the CVD or by quantizing a quantified value into a plurality of stages (classes) and assigning an ID to each stage or the like.

Familiarity may be obtained using a statistical value or the like of scores assigned by examinees with respect to perceived familiarity of each word (how familiar each word is) . For example, examinees are asked to assign familiarity by being presented with only a notation of a word. Alternatively, in order to improve coverage, in consideration of absorbing orthographic variability [symbol] , and [symbol] are all handled as one word), examinees may be asked to assign familiarity by being presented with both a pronunciation and a notation of a word. Alternatively, examinees may be asked to assign familiarity by being presented with only a notation of a word, only a pronunciation of the word, or both the pronunciation and the notation of the word. In a similar manner, a score obtained by quantifying imageability (mental imagery) or the like may be used as the feature amount.

For example, the word database 28 stores the familiarity of each word as shown below.
00000123, [symbol] 6.688, 6.375, 6.625
00000234, [symbol] 6.469, 6.312, 6.500

Note that items described above represent, from left to right, an ID, a notation, a reading, VA (familiarity when notation and pronunciation are presented), A (familiarity when only pronunciation is presented), and V (familiarity when only notation is presented).

With verbs or verbal nouns, event-nouns, adjectives or adjective verbs, and the like (hereinafter, declinable words), a necessary argument (or case) or an argument required as a prerequisite is determined. For example, in the case of the verb [symbol] (pass), conceivable arguments to be taken include [symbol] (who), [symbol] (to whom), and [symbol] (what). These arguments potentially exist even when they are not explicitly described in a sentence. The number of such arguments to be taken by a declinable word will be referred to as “the number of arguments to be potentially taken by a declinable word”. As the number of arguments to be potentially taken by each declinable word, for example, the verb [symbol] (pass) : 3, the verb [symbol] (read) : 2, and the verb [symbol] (begin) : 1 are stored in the word database 28. In addition, a positional relationship between a declinable word and an argument such as whether these arguments explicitly appear in a target text or are omitted therefrom, even when the arguments appear, whether they appear in a different sentence, or whether the declinable word and the argument are inverted (for example, [symbol] (a passed book) is conceivably an inversion of [symbol] (to pass a book) ) may conceivably be used as a feature amount.

As an appearance frequency of a word, a word frequency (hereinafter, denoted as FREQ) that represents a frequency at which a certain word appears in a picture book corpus, the CHILDES corpus, or a corpus created from contents intended for children to be targeted or a document frequency (hereinafter, denoted as DF) that represents the number of documents in which a certain word appears in a target corpus is used.

In addition, as the basic word set, at least one or more basic word sets in the basic corpora described below may be used. For example, at least one or more basic word set may be used from a basic word set created from words that appear in a picture book corpus or the CHILDES corpus or high-frequency words which are words that appear at a high frequency in these corpora, a basic word set created from words of which familiarity is equal to or higher than a reference value (for example, 6), when children of school age and higher ages are to be targeted, a basic word set for each school year created in a similar manner using a textbook, a children’s newspaper, or the like, and a basic word set created from a general document, a balanced corpus, or the like. In addition, for example, a basic word set may conceivably be created using only a picture book intended for infants in the case of a picture book corpus or using only a textbook intended for early elementary grades in the case of a textbook corpus. A basic word set may be prepared for each part of speech.

In this case, the picture book corpus is a picture book corpus constituted by body text data of each picture book in a picture book database presently being constructed as described in NPL 2. The picture book database is constructed for the purpose of recommending picture books in accordance with studies conducted in the field of developmental psychology or in accordance with interests and development of children, and picture books therein are selected to as to include bestsellers, perennially popular picture books, and books recommended by experts.

[NPL 2] Sanae Fujita, Takashi Hattori, Tessei Kobayashi, Yuko Okumura, Kazuo Aoyama, “Picture-Book Search System “Pitarie”: Finding Appropriate Books for Each Child”, The Association for Natural Language Processing “Journal of Natural Language Processing”, Vol. 24, No. 1, 2017.

The CHILDES corpus is a corpus containing transcripts of speech made by infants and speech directed towards infants.

The balanced corpus refers to the Balanced Corpus of Contemporary Written Japanese (hereinafter, abbreviated as BCCWJ) created by the National Institute for Japanese Language and Linguistics. The BCCWJ is a corpus created for the purpose of attempting to grasp the breadth of contemporary written Japanese. The BCCWJ provides information on morphological analysis and tags related to sentence structure, and contains corpora divided into various genres such as general books, general magazines, newspapers, business reports, blogs, Internet forums, textbooks, and legal documents.

In the present embodiment, the feature amount extracting unit 30 extracts items listed below as feature amounts from each text of a picture book acquired from the text database 8. The items include: an acquisition period of a word included in the text; for each category related to the word, an acquisition period of the word included in the text; for each category related to the word, a ratio of words which are included in the text and which belong to the category; familiarity of the word included in the text; imageability of the word included in the text; the number of arguments (or cases) to be potentially taken by a declinable word included in the text or the number of arguments that explicitly appear in the text; a positional relationship between an argument and a declinable word that appear in the text and a type of the declinable word; for each category related to the word, a ratio of nouns and/or declinable words which are included in the text and which belong to the category; with respect to each of a plurality of types of basic word sets, a ratio of words included in the basic word set and/or a ratio of words not included in the basic word set among words included in the text; an appearance ratio of parts of speech; content of words that include repetitions; and diversity of vocabulary. In this case, as declinable words, conceivably, only verbs may be used or only verbs and verbal nouns may be used.

In addition, when a basic word set is to be prepared for each part of speech, the feature amount extracting unit 30 may extract items below as feature amounts. Example of the items includes, with respect to each basic word set for each part of speech, a ratio of words included in the basic word set and/or a ratio of words not included in the basic word set among words of the part of speech that is included in the text.

While the feature amount extracting unit 30 extracts items below as feature amounts in the present embodiment, items to be extracted are not limited thereto. As already described, the items include: an acquisition period of a word included in the text; for each category related to the word, an acquisition period of the word included in the text; for each category related to the word, a ratio of words which are included in the text and which belong to the category; familiarity of the word included in the text; imageability of the word included in the text; for each category related to the word, familiarity of the word included in the text; for each category related to the word, imageability of the word included in the text; the number of arguments of a declinable word and a type of the declinable word that is included in the text; for each category related to the word, a ratio of nouns and/or declinable words which are included in the text and which belong to the category; with respect to each of one or more types of basic word sets, a ratio of words included in the basic word set and/or a ratio of words not included in the basic word set among words included in the text; an appearance ratio of parts of speech; content of words that include repetitions; and diversity of vocabulary. In addition to these feature amounts, the feature amount extracting unit 30 may extract other feature amounts obtained from the text including ratios of hiragana, katakana, and kanji that are included in the text, an average value of the number of characters included in one sentence, an average value of the number of words, an average value of the number of clauses, and an average value of the number of predicates. The feature amount extracting unit 30 may extract a feature amount which includes at least one of items below that are considered feature amounts. In this case, the items include: an acquisition period of a word included in the text; for each category related to the word, an acquisition period of the word included in the text; familiarity of the word included in the text; for each category related to the word, familiarity of the word included in the text; imageability of the word included in the text; the number of arguments of a declinable word and a type of the declinable word that is included in the text; for each category related to the word, a ratio of nouns and/or declinable words which are included in the text and which belong to the category; and with respect to each of one or more types of basic word sets, a ratio of words included in the basic word set and/or a ratio of words not included in the basic word set among words included in the text. In addition, in these cases, only items that are necessary for extracting a feature amount may be stored in the word database 28

The respective feature amounts described above to be extracted by the feature amount extracting unit 30 will be described in detail below.

### Acquisition Period of Word Included in Text

As an acquisition period of a word included in a text, the feature amount extracting unit 30 matches a word in the CVD that is stored in the word database 28 with a word that appears in a target text and extracts, as a feature amount, one of or both of an average value and a maximum value of production days in the CVD of the word that appears in the target text.

For example, the following feature amounts are extracted when one of or both an average value and a maximum value of production days in the CVD are used.

Adding IDs in the CVD to a tail end of a morphological analysis result of a text “ [symbol] ” (Children were surprised) produces the following result. [symbol] noun, common noun, general, *, *, *, [symbol] [symbol] *, *, *, * B-00000123 [symbol] suffix, nominal, general, *, *, *, [symbol] [symbol] *, *, *, * [symbol] particle, binding particle, *, *, *, *, [symbol] *, *, *, * B-00000345 blank, *, *, *, *, *,,,,,,, symbol, *, *, *, * [symbol] noun, common noun, capable of sa-line irregular conjugation, *, *, *, [symbol] *, *, *, * 00000234 [symbol] verb, non-self-sustainable, *, *, sa-line irregular conjugation, conjunctive-general, [symbol] *, *, *, * I-00000234 [symbol] auxiliary, *, *, *, auxiliary- [symbol] end-form-general, [symbol] [symbol] *, *, *, * B-00000456 auxiliary symbol, period, *, *, *, *,, ₒ, ₒ,, ₒ,, symbol, *, *, *, *

The example described above uses a format called a BIO tag. A BIO tag is a format that is often used by being added to a proper noun and B, I, and O respectively represent beginning, intermediate, and other. While O is not added in the example described above, O may be added instead.

Although [symbol] (be surprised) is divided into [symbol] [symbol] and [symbol] in a morphological analysis, since the words are clumped together in the CVD, [symbol] being B and [symbol] being I collectively correspond to an item with an ID of 00000234 in the CVD.

However, when [symbol] appears independently in the text, [symbol] is not associated with the item with the ID of 00000234 in the CVD. It should be noted that, since the independent verb [symbol] [symbol] is assigned a different ID as a self-sustainable verb in the CVD, whenever [symbol] appears independently in the text, [symbol] is associated with the ID of the self-sustainable verb

[symbol]

In addition, in the example of the text [symbol] [symbol] described above, values in the CVD are as follows.

00000123, [symbol] 1, person, 31.0855502360271, 27.0035830656026 00000345, [symbol] 1, article/auxiliary, 27.4366201342289, 26.7774242029008 1696, [symbol] 1, emotion, 30.6868045540324, 26.302268434856 1959, [symbol] ,1, article/auxiliary, 24.7624774749285, 22.7216817167811

Respective items in the values described above represent, from left to right, an ID, an entry word, a classification, a category, production (50% acquisition age in months), and comprehension (50% acquisition age in months).

When using “production (50% acquisition age in months)”, an average of “production (50% acquisition age in months) ” of words that appear in the text may be calculated as follows.

(31.0855502360271 + 27.4366201342289 + 30.6868045540324 + 24.7624774749285)/4 = 28.492863099804225

In addition, a maximum value of “production (50% acquisition age in months)” of words that appear in the text is 31.0855502360271 which is the value of “production (50% acquisition age in months)” of [symbol] (child).

When difficulty is to be estimated for each text, the feature amount extracting unit 30 extracts, for each text, an average value or a maximum value of the acquisition periods of respective words that are included in the text. When a person carrying out the present invention desires to estimate difficulty in a unit (for example, for each page, sentence, or paragraph) other than a text, the average value or the maximum value of the acquisition periods of the respective words may be extracted at a location corresponding to the unit to be estimated.

In addition, the feature amount extracting unit 30 may extract both the average value and the maximum value of the acquisition periods of respective words as feature amounts.

Conceivably, words that are picked up by a child at an early age are relatively simple words and words that are picked up by the child after growing up are difficult words. In consideration thereof, by using an acquisition period of a word as a feature amount as described above, a feature that gives a general idea as to how early in a child’s life a used word is picked up by the child (whether the used word is picked up at an early age or picked up after growing up) can be reflected in the estimation of difficulty. In addition, the use of an average value of acquisition periods enables an average period during which children pick up a word that appears in the text (in other words, whether there are many or few words that are picked up at an early age) can be reflected. Furthermore, the use of a maximum value enables a feature that indicates when words to be picked up the latest are picked up to be reflected.

### For Each Category Related to Word, an Acquisition Period of Word Included in Text

Next, an example in which an acquisition period of a word included in a text for each category related to words is adopted as a feature amount will be adopted as a feature amount will be described.

When matching a word in a text with the CVD, the matching may be performed for each category. For example, as categories related to words, categories such as “animal”, “vehicle”, “household goods”, “pronoun”, “interrogative”, “word representing an action”, and “word representing a state” may be classified and an acquisition period of a word included in the text may be extracted in a similar manner to that described above for each category related to the word. “In a similar manner to that described above” means, specifically, for each category, a word belonging to the category among words in the CVD that is stored in the word database 28 is matched with a word that appears in a target text, and one of or both an average value and a maximum value of production days in the CVD of the word that appears in the target text are extracted as a feature amount.

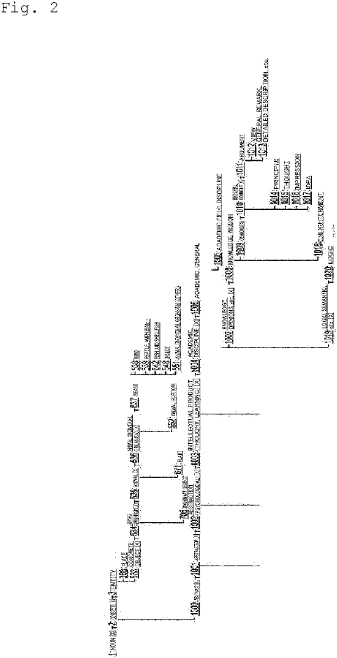

As a method of classifying categories, the classifications described below may be used. Examples of classifications that may be used include: categories of the CVD; classifications of a thesaurus such as GoiTaikei - A Japanese Lexicon (refer to FIG. 2) or the Word List by Semantic Principles (conceivable classification methods include determining leaf nodes, intermediate nodes, and use nodes using a frequency of a word that appears in each node as a threshold); and a classification of a concept dictionary of the EDR electronic dictionary (in which a hierarchical conceptual structure and words included in each school year are defined: Internet: refer to <URL: http://www2.nict.go.jp/ipp/EDR/JPN/TG/Doc/EDR_J04a.pdf>). Alternatively, only a category (such as names of concrete objects) with a high correlation between an appearance frequency in a corpus and an acquisition period such as an appearance frequency in picture books from around the world may be used.

This is because the present inventors and the like have scientifically proven that the higher the frequency of appearance of a word in picture books, the higher the age in months of infants acquiring that word and that an intensity of this tendency varies from one category to the next. For example, in categories of vehicles and animals, the higher the frequency, the earlier the acquisition period (refer to NPL 3).

[NPL 3] Sanae Fujita, Tessei Kobayashi, Yuko Okumura, Takashi Hattori “Youji no Goi Kakutoku to Ehon kopasu no Kankei wo Saguru” (Finding the Relationship Between Child Vocabulary Acquisition and Picture Book Corpus), Proceedings of the 23rd Annual Meeting of the Association for Natural Language Processing (NLP-2017), pp. 899--902, Tsukuba, C6-2, 2017.3.

Although categories with a high correlation between an appearance frequency in a corpus and an acquisition period exhibit a trend in that the higher the frequency, the later the acquisition period, categories exist in which there is hardly any correlation between frequency and an acquisition period. Using only categories with a high correlation enables a word that conceivably accurately reflects difficulty of the word to be used as a feature amount.

In addition, a plurality of types of classification methods of categories may be used in combination.

For example, an average value and a maximum value of acquisition periods of words belonging to the “animal” category and an average value and a maximum value of acquisition periods of words belonging to the “onomatopoeia/mimeticword” category that appear in a target text may be extracted as feature amounts.

By extracting a feature amount in categories as described above, adjusting other conditions (presence or absence of parts of speech, conjugation, and the like that conceivably affect difficulty) as much as possible enables reliability of an acquisition period as an indicator of difficulty to be improved.

For example, using the “animal” category and the “onomatopoeia/mimetic word” category without distinction as a feature amount, feature amounts that represent difficulty in an order of [symbol] (cat < flat < sea otter < “saboon”)are extracted.

532, [symbol] 1, animal, 25.7693158612872, 19.4885511769964 407, [symbol] 1, onomatopoeia/mimetic word, 26.0364339727761, 20.153005159889 555, [symbol] 1, animal, 37.3564025311432, 29.6474071490029 455, [symbol] 1, onomatopoeia/mimetic word, 38.3374588300544, 34.3004374461354

On the other hand, extracting feature amounts while distinguishing between the “animal” category and the “onomatopoeia/mimetic word” category results in extracting feature amounts representing the following contents.

Animal: [symbol] (cat < sea otter) Onomatopoeia/mimetic word: [symbol] (flat < “saboon”)

The “onomatopoeia/mimetic word” category is a category in which there is hardly any correlation between frequency and an acquisition period.

By classifying into categories in this manner, conditions in each category can be adjusted as much as possible and difficulties in a same category can be compared. In addition, among such categories, only categories of which reliably is conceivably high can be used as a feature amount.

Furthermore, together with extracting an average value and a maximum value of the acquisition period of each word included in a text for each category as feature amounts, an average of average values and an average of maximum values of the acquisition period across all categories may be extracted as feature amounts.

By classifying into categories in this manner, words with a high correlation with a difficulty of a word or a text can be separated from words with low correlation or words belonging to a category that is difficult to learn can be separated from words that are easily picked up.

### For Each Category Related to Word, Ratio of Words Belonging to Category and Included in Text

In addition, the feature amount extracting unit 30 may extract a ratio of the number of words in a category that is difficult to learn to the whole as a feature amount.

For example, compared to the “animal” category, words belonging to an “action” category are more difficult and, even among names, “pronouns”, abstractions, and generic concepts are words that are more difficult than names of “animals” and “vehicles” which are concrete objects. A ratio of words in more difficult classes or the like may be extracted as a feature amount. In a similar manner, the “onomatopoeia/mimetic word” category is a category containing words that are easy to pick up. Therefore, although a correlation between frequency and an acquisition period is low in the category, a ratio of words in such categories may conceivably be used as a feature amount. Accordingly, a feature of appearance of simple words can be reflected in the estimation of difficulty.

### Familiarity of Word Included in Text

As familiarity of a word included in a text, the feature amount extracting unit 30 matches a word which is stored in the word database 28 and to which familiarity has been added with a word that appears in a target text and extracts, as a feature amount, one of or both an average value and a maximum value of familiarity of the word that appears in the target text.

In the case of the example of the text [symbol] [symbol] described above, [symbol] and [symbol] match words which are stored in the word database 28 and to which familiarity has been added in advance.

### For Each Category Related to Word, Familiarity of Word Included in Text

In addition, in the present embodiment, matching of a word in a text with a word to which familiarity has been added is performed for each category in a similar manner to an acquisition period. For example, as categories related to words, categories such as “animal”, “vehicle”, “household goods”, “pronoun”, “interrogative”, “word representing an action”, and “word representing a state” may be classified and familiarity of a word included in the text may be extracted in a similar manner to that described above for each category related to the word.

For example, a category having a high correlation between frequency and familiarity is used. In such a category, since there is a trend that the higher the frequency, the lower the familiarity, a portion in which reliability of familiarity is high can be used as a feature amount.

In addition, since a word with high familiarity is a familiar word and, conversely, a word with low familiarity is an unfamiliar word, extracting a value of familiarity of a word that appears in a text as a feature amount contributes toward estimating difficulty.

Furthermore, since both an acquisition period and familiarity of a word are extracted as feature amounts in the present embodiment, the number of feature amounts doubles (such as using an average value and a minimum value or a maximum value of acquisition periods and an average value and a minimum value or a maximum value of familiarity).

### For Each Category Related to Word, Integrated Value of Acquisition Period and Familiarity of Word Included in Text

For each word included in a text, an acquisition period and familiarity of the word may be integrated to create a single feature amount. In this case, there are two conceivable integration methods as described below.

In a first integration method, with respect to a word included in a text, after changing the familiarity of the word in accordance with the acquisition period of the word, the acquisition period and the familiarity of the word are integrated. For example, in the case of a word acquired by age 3, high familiarity set in advance is adopted as an integrated value regardless of an originally added value of familiarity. Alternatively, high familiarity set in advance in stages such as a value of a word acquired by age 3, a value of a word acquired by age 4, and so on is adopted as an integrated value. In addition, familiarity that is set in finer detail in accordance with the CVD may be adopted as an integrated value, or a function that uses an acquisition period of a word and familiarity of the word as parameters to obtain an integrated value may be determined in advance and an integrated value may be obtained by inputting an acquisition period of a word and familiarity of the word to the function. Using familiarity measured with respect to adults for ages 7 and higher and using an integrated value having been corrected using these methods for ages lower than 7 enable familiarity measured with respect to adults to be corrected to be used for children.

In addition, since familiarity of [symbol] (dog) is higher than that of [symbol] (bowwow), singularly using only familiarity creates a problem in that a reverse phenomenon occurs where a text in which [symbol] appears becomes simpler than a text in which [symbol] [symbol] appears. In the first integration method, this problem can be solved by correcting familiarity of a word to be initially acquired to higher familiarity using age around 3 years-old as a threshold.

In a second integration method, conversely, with respect to a word included in a text, the acquisition period and the familiarity of the word are integrated using a value obtained by changing the acquisition period of the word in accordance with the familiarity of the word. In this case, with respect to a word which is not included in the CVD but to which familiarity has been added, an integrated value is obtained by imparting an acquisition period such that the lower the familiarity, the higher the acquisition period.

With this integration method, familiarity measured using adults can be brought close to an acquisition period measured using children.

In addition, when integrating an acquisition period with familiarity of a word, words not included in the CVD may be integrated after estimating an acquisition period. When estimating the acquisition period of a word, for example, a regression equation that represents a correlation between an acquisition age in days of the word by infants and an appearance frequency in a corpus is obtained in advance using log (DF) as the appearance frequency of the word in the corpus, and acquisition age in days is estimated using the regression equation with respect to words not included in the CVD.

A frequency of a word in the CVD, a picture book corpus, or the CHILDES corpus (a corpus containing transcripts of speech made by infants and speech directed towards infants) has an extremely high correlation with a vocabulary acquisition age in days. In consideration thereof, even with respect to a word of which a vocabulary acquisition age in days are unknown, an acquisition age in days can be estimated from an appearance frequency. A result of estimation performed in this manner is used when extracting, as a feature amount, an acquisition period or familiarity of a word included in a text, an acquisition period or familiarity of the word for each category, and an integrated value with the acquisition period. Accordingly, coverage can be increased and cases where a word cannot be estimated because the word is unknown can be reduced.

It should be noted that estimation may be performed using a regression equation in a similar manner even when estimating an acquisition age in months instead of an acquisition age in days.

In addition, imageability (mental imagery) (NPL: Nihongo-no Goitokusei: Lexical Properties of Japanese: Third Period (vol. 9) https://www.sanseido-publ.co.jp/publ/ep/RD/RD04.html) may conceivably be used in a similar manner to the CVD or word familiarity.

Imageability refers to ease of recall of sensory imagery or kinesthetic imagery of a word. For example, it is more difficult to recall imagery of [symbol] (trend) or [symbol] (plus) than to recall imagery of [symbol] (apple) or [symbol] (tennis) . Since an imageable word is conceivably more readily imaged and picked up even by infants, using these feature amounts enables a feature indicating whether or not there are many words that are readily imaged and picked up or the like to be reflected.

### Number of Arguments of Declinable Words and Type of Declinable Words Included in Text

As the number of arguments of declinable words included in the text, for example, whether a verb included in the text is an intransitive verb or a transitive verb is extracted as a feature amount.

This feature amount assumes that a transitive verb that takes two or three arguments is more difficult than an intransitive verb that takes only one argument. A ratio of appearance of intransitive verbs that take only one argument among all verbs or a ratio of appearance of intransitive verbs that take two or more arguments among all verbs may be extracted as feature amounts. Alternatively, feature amounts may be obtained based on a more detailed classification that includes a ratio of appearance of intransitive verbs that take only one argument, a ratio of appearance of transitive verbs that take only two arguments, and a ratio of appearance of transitive verbs that take three or more arguments.

A text including the verb [symbol] (pass) takes the form of, for example, [symbol] (A passes C to B) and, therefore, [symbol] has three arguments; a text including the verb [symbol] (read) takes the form of, for example, [symbol] (A reads B) and, therefore, [symbol] has two arguments; and a text including the verb [symbol] (begin) takes the form of, for example, [symbol] (A begins) and, therefore, [symbol] has one argument.

Since Japanese is a language with many omissions, for each verb, a description that the verb is a word that may potentially take a certain number of arguments is paired with the verb and stored in the word database 28 in advance, and the number of arguments (the number of arguments of an indispensable case) described in “a word that may potentially take a certain number of arguments” which is stored for each extracted verb is read and used.

In addition, as a method of obtaining a ratio, for example, a ratio of verbs that potentially take three arguments among all verbs in a target text may be calculated.

Alternatively, a ratio of intransitive verbs and a ratio of transitive verbs may be simply used as feature amounts without performing segmentation.

Furthermore, since Japanese is a language with many omissions and, therefore, it is difficult to clearly specify the number of potential arguments of a verb, the number of arguments of the verb (or an adjective) that actually appear in a text may be extracted as a feature amount instead of using the number of potential arguments of the verb.

For example, in a text [symbol] (He passes a book to her), since three arguments appear as arguments of the verb [symbol] (pass), it is assumed that the number of arguments of the verb is three. On the other hand, in a text [symbol] (to pass a book to her), since two arguments appear as arguments of the verb [symbol] it is assumed that the number of arguments of the verb is two.

In addition, as the type of declinable word included in the text, for example, whether or not the declinable word is a verb that takes a particle other than the particles [symbol] and [symbol] is extracted.

As a classification of verbs, in addition to a simple classification into “intransitive verbs” and “transitive verbs”, detailed classifications into several tens to several hundreds of types are conceivable. For example, GoiTaikei – A Japanese Lexicon classifies verbs into approximately 130 types. Table 1 below presents a part of this classification.

TABLE 1

Declinable Word Semantic Attribute Marking Criteria
0100: Event

| | | | | | |
|---|---|---|---|---|---|
| 0200 State | 0300 Abstract relations | 0400 Existence | 0401 | N1 exists in N3/N8; dwell | [symbol] |
| | | | 0402 | N1 does not exist | [symbol] |
| | | 0500 Attribute | 0501 | Intrinsic attribute of N1 (other than person/entity); characteristics | [symbol] |
| | | | 0502 | Intrinsic attribute of N3; characteristics | [symbol] |
| | | | 0503 | Intrinsic attribute of N8; characteristics | [symbol] |
| | | | 0504 | Intrinsic attribute of N1 (person/entity/animal); characteristics | [symbol] |
| | | | 0505 | Characteristics of N1 (person/animal); personality | [symbol] |
| | | | 0506 | State of N1 | [symbol] |
| | | 0600 | | N1 holds N2; store | [symbol] |
| | | 0700 Relative relations | 0701 | Relationship between N1 and N3 | [symbol] |
| | | | 0702 | Relationship between N1 and N2 | [symbol] |
| | | | 0703 | Relationship between N1 and other (object is vague) | [symbol] |
| | | 0800 Causal relationships | 0801 | N1 occurs from N3/N12; attributable to | [symbol] |
| | | | 0802 | N1 causes N2 | [symbol] |
| | | | 0803 | N1 causes N3 | [symbol] |
| | | | 0804 | N1 arises from N2 (N2 is cause) | [symbol] |
| | 0900 Mental relations | 1000 Perceptual state | 1001 | Perceptual state of N1 (person) | [symbol] |
| | | | 1002 | Perceptual state of N1 (entity) | [symbol] |
| | | | 1003 | Perceptual state of N1 (person/animal) | [symbol] |
| | | | 1004 | Perceptual state of N3 | [symbol] |
| | | 1100 Emotional state | 1101 | Emotional state of N1 (person) | [symbol] |
| | | | 1102 | Emotional state of N1 (entity) | [symbol] |
| | | | 1103 | Emotional state of N1 (person/animal) | [symbol] |
| | | | 1104 | Emotional state of N3 | [symbol] |
| | | | 1201 | Intellectual state of N1 (person) | [symbol] |

While such detailed classifications may conceivably be used, since an excessively detailed classification ends up producing a sparse result, in the present embodiment, verbs are divided into two types, namely, verbs that only take the particle [symbol] (ga) or only take the particles [symbol] and [symbol] (wo) and verbs that take other particles, and feature amounts are extracted accordingly. Alternatively, verbs may be divided into three types, namely, verbs that only take the particle [symbol] verbs that only take the particles [symbol] and [symbol] and verbs that take other particles, and feature amounts may be extracted accordingly.

Verbs that take a plurality of arguments are more difficult. Specifically, phenomena that can be expressed by the verb conceivably becomes that much complex, and a most basis verb is a verb that only takes [symbol] which may be taken by all verbs and adjectives [symbol] may be replaced with [symbol] in a case of a superficial particle) . Second most common verbs are those that take [symbol] followed by other verbs that are significantly less numerous. Therefore, when particles that hardly appear are considered difficult, verbs that take particles other than [symbol] and [symbol] can be assumed to be relatively difficult and a feature amount can be extracted accordingly.

### Appearance Ratio of Parts of Speech

As an appearance ratio of a part of speech included in the text, for example, an appearance ratio of specific parts of speech that bundle “verbs”, “adjectives”, and “adjective verbs” which are parts of speech of conjugating words is extracted as a feature amount. For example, when the total number of words with the exception of blanks is 7 and the number of specific parts of speech that bundle “verbs”, “adjectives”, and “adjective verbs” is 3, 3/7 is adopted as the ratio of the specific parts of speech.

Conjugating words are considered words that are difficult to learn and pick up even at the time of learning by children. In consideration thereof, in the present embodiment, bundling parts of speech of conjugating words and using a ratio of the parts of speech of conjugating words as a feature amount enables a ratio of all conjugating words that would be dispersed when only considering parts of speech to be extracted as a feature amount.

In addition, an appearance ratio of specific parts of speech that bundle “adverbs” and “interjections” that readily become onomatopoeia and mimetic words may be extracted as a feature amount.

For example, with a text in which only onomatopoeia appears, using a classification of onomatopoeia for a feature amount requires a dictionary for determining which word is an onomatopoeia. However, normally, since onomatopoeia is constituted by adverbs and interjections, using a ratio of parts of speech that bundle adverbs and interjections as a feature amount enables the feature amount to be readily extracted without having to determine which word is an onomatopoeia.

### Content of Words That Include Repetitions in Text

In addition, as the content of words that include repetitions, for example, a ratio of words with repetition such as [symbol] (bowbow) and [symbol] (zaazaa) is extracted as a feature amount.

There are study results suggesting that words with repetition such as [symbol] and [symbol] include words that are often directed towards infants and that such words are more easily picked up by infants . In terms of distinguishing by parts of speech, depending on context, even the same [symbol] may be either a “noun” or an “exclamation” and [symbol] may be either an “adverb” or an “exclamation”. In the present embodiment, by bundling such words with repetition from the perspective of recognizability by infants instead of parts of speech, the words with repetition can be used as a feature amount.

### For Each Category Related to Word, Ratio of Nouns and/or Declinable Words Belonging to Category and Included in Text

In addition, for each category related to words, as a ratio of nouns belonging to the category and included in the text, a ratio of nouns for each category is extracted using, for example, whether a noun is a name in a “concrete object” category such as a name of an animal or a vehicle or a name in an “abstraction” category.

Furthermore, various granularities are conceivable as a granularity of categories from a granularity of “concrete objects” and “abstractions” to a granularity of “animals”, “vehicles”, “foods”, and the like and the granularity is not limited to a 2-way classification of “concrete objects” and “abstractions”.

In addition, a degree of bias among categories indicating whether or not there is overconcentration in a certain category may be extracted as a feature amount.

Furthermore, in addition to nouns, for each category related to verbs, a ratio of declinable words belonging to the category and included in the text may be extracted as a feature amount.

For example, a ratio of verbs for each category is extracted according to classifications such as an “abstract” category including “move” and a “concrete” category including “run”, “walk”, and “jump”.

In addition, in conformance to Table 1 described above, a ratio of verbs for each category may be extracted according to a classification of “abstract relations”, “psychological relations”, “physical action”, “mental action”, and “other” which constitute a second tier or a ratio of verbs for each category may be extracted according to a more detailed classification of “existence”, “attribute”, “causal relationships”, and the like.

Since words with high concreteness are considered to be words that are readily learned, including the concreteness of a word as a feature amount as described above enables a feature of whether or not the word is a simple word to be reflected in the feature amount even among words belonging to a same part of speech.

### Diversity of Vocabulary

As a diversity of a vocabulary, for example, the number of differences in words or the number of differences in words/the total number of words with respect to an entire text is extracted as a feature amount.

The number of differences in words/the total number of words decreases if a same word appears but increases if different words appear. In addition, while this ratio increases when a target age rises (in other words, when difficulty increases), such a feature can be reflected in the feature amount.

For example, with respect to sections [symbol] and [symbol] [symbol] the number of differences in words/the total number of words is calculated according to any of two calculation methods described below. Either one of the two calculation methods may be used as long as a same calculation method is used during learning and during estimation.

In a first calculation method, the sections are broken down into [symbol] and [symbol] by morphological analysis, 4 Tokens of [symbol] and [symbol] result in the total number of words being 4, 3 Types of [symbol] and [symbol] result in the number of differences in words being 3, thereby resulting in the number of differences in words/the total number of words being ¾.

In a second calculation method, the sections are broken down into [symbol] and [symbol] by morphological analysis, 8 Tokens of [symbol] and [symbol] result in the total number of words being 8, 5 Types of [symbol] and [symbol] result in the number of differences in words being 5, thereby resulting in the number of differences in words/the total number of words being ⅝.

In this case, in order to make a comparison in a uniform total number of words, for example, an average of the numbers of differences in words included in 100 words may conceivably be used.

In addition, by studying a change in the number of differences in words/the total number of words in advance when the number of words are increased to 30 words, 50 words, 70 words, and 100 words from a plurality of texts, even when estimating difficulty of a text that only contains 50 words, the number of differences in words/the total number of words when the number of words reaches 100 can be predicted and the predicted value can be used.

### With Respect to Each of Plurality of Types of Basic Word Sets, Ratio of Words Included in the Basic Word Set and/or a Ratio of Words Not Included in the Basic Word Set Among Words Included in Text

With respect to each of a plurality of types of basic word sets, as a ratio of words included in the basic word set and/or a ratio of words not included in the basic word set among words that are included in the text, for example, words recorded in the CVD are considered to constitute the basic word set and whether or not a word appears therein is used as a binary feature amount.

Accordingly, a degree of inclusion of words that do not belong to basic words (words that are generally not picked up by many children in their infancy) can be extracted as a feature amount. For example, (a) texts of which 80% is constituted by words included in the CVD (in other words, words picked up by age 3) and 20% is constituted by other words or (b) texts of which 100% is constituted by words included in the CVD can be distinguished from one another.

In the present embodiment, at least two or more types of basic word sets among the basic word sets described below are used in combination. In this case, specific examples of basic word sets include: a basic word set created from words that appear in a picture book corpus or the CHILDES corpus or high-frequency words that appear in these corpora, a basic word set created from words of which familiarity is equal to or higher than a reference value (for example, 6) ; when children of school age and higher ages are to be targeted, a basic word set for each school year created in a similar manner using a children’s textbook, a children’s newspaper, or the like; and a basic word set created from a general document, a balanced corpus, or the like. Accordingly, for example, (c) texts of which 90% of words appear in a basic word set for 3rd grade or below and a remaining 10% of words appear in a basic word set for 6th grade or below, (d) texts of which 90% of words appear in a basic word set for 3rd grade or below and a remaining 10% of words appear in a basic word set for junior high-school or below, and the like can be distinguished from one another.

Based on a feature amount extracted with respect to each text of a picture book by the feature amount extracting unit 30 and a feature amount added to each text of the picture book, the difficulty estimation model generating unit 32 generates a difficulty estimation model for estimating difficulty of the text of the picture book and stores the difficulty estimation model as the difficulty estimation model 40.

Specifically, the difficulty estimation model generating unit 32 learns a difficulty estimation model by a ranking SVM. Let us assume that, when difficulty of a picture book is considered a class, combinations of classes of 4 > 3, 4 > 2, 4 > 1, 3 > 2, and 2 > 1 are provided. With respect to each combination of classes, a feature amount extracted from each text of the picture book is used to compare all pairs of the picture book belonging to the class and to learn a ranking SVM. Alternatively, a difficulty estimation model may be learned using a random forest. When using a random forest, decision tree learning is performed. For example, the difficulty estimation model generating unit 32 randomly selects an arbitrary feature amount from a plurality of (such as 100) feature amounts and creates a single decision tree. A weak classifier is generated by creating a plurality of decision trees in this manner. In addition, by group learning, a plurality of (for example, 100 decision trees with different combinations of feature amounts are created and a result thereof is averaged to obtain a final output. Since the greater the number of feature amounts to be used in learning and the greater the number of decision trees to be created, the higher the accuracy, the number of feature amounts to be used in learning and the number of decision trees to be created may be determined in combination with a calculation cost that is required for learning. Alternatively, a classifier may be used as a difficulty estimation model to be learned.

### Configuration of Difficulty Estimation Device According to Embodiment of Present Invention

Next, a configuration of a difficulty estimation device according to the embodiment of the present invention will be described.

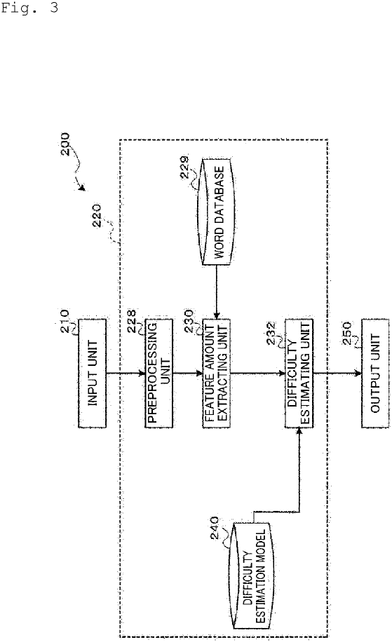

As shown in FIG. 3, a difficulty estimation device 200 according to the embodiment of the present invention can be constructed by a computer that includes a CPU, a RAM, and a ROM storing a program and various types of data for executing a difficulty estimation processing routine to be described later. From a functional perspective, as shown in FIG. 3, the difficulty estimation device 200 is equipped with an input unit 210, a computing unit 220, and an output unit 250.

The input unit 210 accepts input of a text of a picture book. The text of the picture book represents a conversion of characters in the picture book into text data and is a file containing information such as line breaks, blanks, and page breaks in the text, a name of an author, and a name of a publisher.

The computing unit 20 is configured to include a preprocessing unit 228, a word database 229, a feature amount extracting unit 230, a difficulty estimating unit 232, and a difficulty estimation model 240.

As the difficulty estimation model 240, a same difficulty estimation model as the difficulty estimation model 40 is stored.

The preprocessing unit 228 performs normal morphological analysis and adds an analysis result to the text of the picture book. Alternatively, instead of performing a morphological analysis with the preprocessing unit 228, a text of a picture book subjected to a morphological analysis in advance may be accepted by the input unit 210.

The word database 229 stores, in a similar manner to the word database 28, a child vocabulary development database (CVD) storing an acquisition period of each word, familiarity of each word, the number of arguments that each declinable word may potentially take, a frequency of appearance of each word, and a plurality of types of basic word sets.

The feature amount extracting unit 230 extracts, in a similar manner to the feature amount extracting unit 30 described earlier, a feature amount from the text of the picture book to which an analysis result has been added by the preprocessing unit 228. Examples of the feature amount include, as defined in the difficulty estimation model that is stored in the difficulty estimation model 240: an acquisition period of a word included in the text; for each category related to the word, an acquisition period of the word included in the text; for each category related to the word, a ratio of words which are included in the text and which belong to the category; familiarity of the word included in the text; imageability of the word included in the text; for each category related to the word, familiarity of the word included in the text; for each category related to the word, imageability of the word included in the text; the number of arguments (or cases) that a declinable word that is included in the text may potentially take or the number of arguments that explicitly appear in the text, a positional relationship between an argument and a declinable word that appear in the text, or a type of the declinable word; for each category related to the word, a ratio of nouns and/or declinable words which are included in the text and which belong to the category; with respect to each of a plurality of types of basic word sets, a ratio of words included in the basic word set and/or a ratio of words not included in the basic word set among words included in the text; an appearance ratio of parts of speech; content of words that include repetitions; and diversity of vocabulary.

Based on a feature amount of the text of the picture book, extracted by the feature amount extracting unit 230, and the difficulty estimation model 240 obtained in advance in order to estimate difficulty of the text of the picture book, the difficulty estimating unit 232 estimates the difficulty of the text of the picture book.

Specifically, with respect to the text of the picture book, the difficulty estimating unit 232 calculates a score based on the feature amount of the text of the picture book and the difficulty estimation model 240. In addition, the calculated score is determined according to a threshold to estimate a difficulty class. For example, assuming that difficulty classes are classified into any of a class i and a class i+1, a maximum value of scores of picture books included in the class i is denoted by maxᵢ and a minimum value of scores of picture books included in the class i+1 is denoted by minᵢ₊₁. An intermediate value of the maximum value maxᵢ and the minimum value minᵢ₊₁ is adopted as a threshold th, and a difficulty class obtained by estimating that a score lower than th belongs to the class i and a score higher than th belongs to the class i+1 is output to the output unit 250. It should be noted that when a difficulty estimation model is learned using a random forest, a difficulty class is estimated by tracing, in accordance with each extracted feature amount, branches of a plurality of decision trees that have been learned as a classifier in advance and averaging (or taking a majority vote of) results obtained by the respective decision trees. When estimation of a difficulty class need not be performed, a score may be output without using a threshold.

### Operation of Difficulty Estimation Model Learning Device According to Embodiment of Present Invention

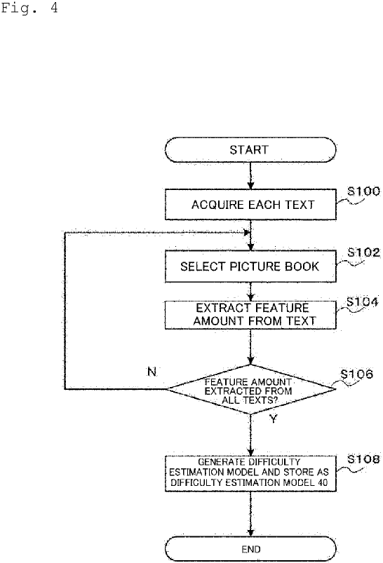

Next, an operation of the difficulty estimation model learning device 100 according to the embodiment of the present invention will be described. When input of each text of a picture book to which a difficulty and an analysis result have been added is accepted by the input unit 10 and stored in the text database 8, the difficulty estimation model learning device 100 executes a difficulty estimation model learning processing routine shown in FIG. 4.

First, in step S100, each of the texts of the picture book stored in the text database 8 is acquired.

Next, in step S102, a text of the picture book to be a processing object is selected.

In step S104, the difficulty estimation model learning device 100 extracts the items listed below as a feature amount from the text of the picture book selected in step S100. Examples of the feature amount extracted at this point include: a feature amount including an acquisition period of a word included in the text, for each category related to the word, an acquisition period of the word included in the text, for each category related to the word, a ratio of words which are included in the text and which belong to the category, familiarity of the word included in the text, imageability of the word included in the text, for each category related to the word, familiarity of the word included in the text, for each category related to the word, imageability of the word included in the text, the number of arguments that a declinable word included in the text may potentially take or the number of arguments that explicitly appear in the text, a positional relationship between an argument and a declinable word that appears in the text or a type of the declinable word, for each category related to the word, a ratio of nouns and/or declinable words which are included in the text and which belong to the category, with respect to each of a plurality of types of basic word sets, a ratio of words included in the basic word set and/or a ratio of words not included in the basic word set among words included in the text; an appearance ratio of parts of speech; content of words that include repetitions; and diversity of vocabulary.

In step S106, a determination is made as to whether a feature amount has been extracted from texts of all picture books, and if not, a return is made to step S102 to repeat processing, but if so, a transition is made to step S108.

Subsequently, in step S108, based on a feature amount extracted with respect to each text of a picture book in step S104 and a feature amount added to each text of the picture book, a difficulty estimation model for estimating difficulty of the text of the picture book is generated and stored as the difficulty estimation model 40, and processing is ended.

### Operation of Difficulty Estimation Device According To Embodiment of Present Invention

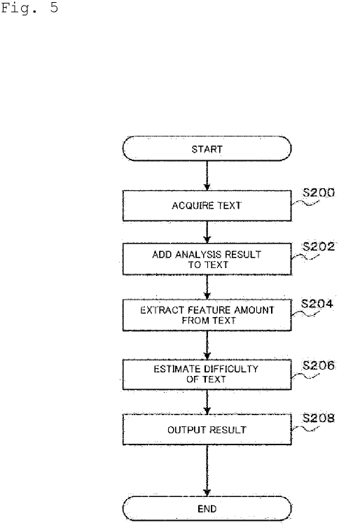

Next, an operation of the difficulty estimation device 200 according to the embodiment of the present invention will be described. When input of a text of a picture book is accepted by the input unit 210, the difficulty estimation device 200 executes a difficulty estimation processing routine shown in FIG. 5.

First, in step S200, the text of the picture book accepted by the input unit 210 is acquired.

Next, in step S202, the text of the picture book acquired in step S200 is analyzed through first to fourth steps of processing and an analysis result is added to the text.

In step S204, the difficulty estimation device 200 extracts the items listed below as a feature amount from the text of the picture book to which an analysis result has been added in step S202. Examples of the items extracted at this point include: an acquisition period of a word included in the text; for each category related to the word, an acquisition period of the word included in the text; for each category related to the word, a ratio of words which are included in the text and which belong to the category; familiarity of the word included in the text; imageability of the word included in the text; for each category related to the word, familiarity of the word included in the text; for each category related to the word, imageability of the word included in the text; the number of arguments that a declinable word included in the text may potentially take or the number of arguments that explicitly appear in the text, a positional relationship between an argument and a declinable word that appear in the text, or a type of the declinable word; for each category related to the word, a ratio of nouns and/or declinable words which are included in the text and which belong to the category; with respect to each of a plurality of types of basic word sets, a ratio of words included in the basic word set and/or a ratio of words not included in the basic word set among words included in the text; an appearance ratio of parts of speech; content of words that include repetitions; and diversity of vocabulary.

In step S206, based on a feature amount of the text of the picture book as extracted in step S204 and the difficulty estimation model 240 obtained in advance in order to estimate difficulty of the text of the picture book, the difficulty of the text of the picture book is estimated.

Subsequently, in step S208, the difficulty estimated in step S206 is output as an estimation result to the output unit 250 and processing is ended.

As described above, with the difficulty estimation device according to the embodiment of the present invention, by extracting feature amounts listed below from an input text, difficulty of the text can be accurately estimated at desired granularity. In this case, examples of the feature amounts include: an acquisition period of a word included in the text; familiarity of the word included in the text; imageability of the word included in the text; at least one or more of the number of arguments of a declinable word and a type of the declinable word that is included in the text; for each category related to the word, a ratio of nouns and/or declinable words which belong to the category; and with respect to each of a plurality of types of basic word sets, a ratio of words included in the basic word set and/or a ratio of words not included in the basic word set among words included in the text.

It should be noted that the present invention is not limited to the embodiment described above and various modifications and applications can be made without departing from the spirit and scope of the present invention.

For example, while the difficulty estimation model learning device according to the embodiment described above has been explained using a case where a feature amount is extracted from a text of a picture book to generate a difficulty estimation model as an example, the present invention is not limited thereto and a feature amount may be extracted from a text included in a textbook, a nursery tale, a nursery rhyme, or the like to generate a difficulty estimation model.

In addition, while the difficulty estimation device according to the embodiment described above has been explained using a case where difficulty of a text of a picture book is estimated as an example, the present invention is not limited thereto and difficulty of a text included in a nursery tale, a nursery rhyme, or the like may be estimated.

Furthermore, while the difficulty estimation model learning device according to the embodiment described above has been explained using a case where a difficulty estimation model is learned using a picture book to which difficulty has been added as an example, the present invention is not limited thereto and a difficulty estimation model for estimating a target period of a picture book may be learned using a picture book to which a target period has been added. In addition, in the difficulty estimation device, a target period of a picture book may be estimated using a difficulty estimation model for estimating a target period. In this case, conceivable examples of the target period include a target age in years, a target age in months, a target age in weeks, a target age in days, in 6-month units (for example, ages for two years, two and a half years, three years, three and a half years and so on),or in accordance with a degree of linguistic development (“when a first word is uttered”, “when a 2-word sentence is uttered”, “when a 3-word sentence is uttered”, or the like).

In addition, difficulty estimation may be performed in two stages. For example, while which of “age 0, age 1, age 2, age 3, age 4, age 5, and ages 6 and higher” is a target period is estimated at one time in the difficulty estimation according to the embodiment described above, which of “ages 0 to 2” and “ages 3 and higher” is a target period may be estimated in difficulty estimation of a first stage, and when an estimation result of the first stage is “ages 0 to 2”, which of “age 0, age 1, and age 2” is the target period may be estimated using, as a feature amount, at least one of an acquisition period of a word included in the text and for each category related to the word, an acquisition period of a word included in the text.

Specifically, any of two configuration examples described below may be used.

In a first configuration example, the learning to rank described above is performed in both difficulty estimation of a first stage and difficulty estimation of a second stage.

First, in the difficulty estimation of the first stage, which of “ages 0 to 2” and “ages 3 and higher” is a target period is estimated using learning to rank in a similar manner to the difficulty estimating unit 232 described above and, subsequently, learning to rank is used in a similar manner with respect to each of “ages 0 to 2” and “ages 3 and higher” to estimate a target period.

Alternatively, in the first-stage difficulty estimation, class separation may be used to estimate which of “ages 0 to 2” and “ages 3 and higher” is a target period or learning for regression may be used to perform the estimation. A feature amount to be used in the first-stage difficulty estimation may be a feature amount that is similar to that in PTL 1 described earlier or a combination of a feature amount that is similar to that in PTL 1 described earlier and a feature amount explained in the embodiment described above.

In addition, in a second-stage difficulty estimation, a feature amount used when estimating which of “age 0, age 1, or age 2” is a target period may differ from a feature amount used when estimating which of “age 3, age 4, age 5, or ages 6 and higher” is a target period.

For example, an acquisition period of a word included in a text may be adopted as the feature amount to be used when estimating which of “age 0, age 1, or age 2” is a target period, and familiarity may be adopted as the feature amount to be used when estimating which of “age 3, age 4, age 5, or ages 6 and higher” is a target period.

In a second configuration example, in difficulty estimation of a first stage, a target period is estimated without using a learner, and in difficulty estimation of a second stage, a target period is estimated using learning to rank in a similar manner to the difficulty estimating unit 232 described earlier.

For example, when estimating which of “ages 0 to 2” and “ages 3 and higher” is a target period in the first-stage difficulty estimation, “ages 0 to 2” is estimated to be the target period using, as a condition, at least one of the number of differences in appearing words being equal to or smaller than a reference value, the number of words, the number of characters, the number of sentences, or the like being equal to or smaller than a reference value, a ratio of words that appear in a basic word set being equal to or higher than a reference value (for example, 90%),and a ratio of words that appear in a set combining a basic word set and onomatopoeia/mimetic words being equal to or higher than a reference value, and in the second-stage difficulty estimation, estimation is performed using learning to rank in a similar manner to the difficulty estimating unit 232 described earlier.

Alternatively, when estimating which of “ages 0 to 2” and “ages 3 and higher” is a target period in the first-stage difficulty estimation, at least one of an acquisition period of a word included in the text and for each category related to words, an acquisition period of a word included in the text may be used as a feature amount. For example, an age in years that matches an average value of acquisition periods of words included in the text may be estimated as a target age in years or an age in years that matches a maximum value of acquisition periods of words included in the text may be estimated as a target age in years.

Accordingly, a decline in estimation accuracy caused by an excessive difference in the numbers of words between “ages 0 to 2” and “ages 3 and higher” can be avoided and, by first estimating which of “ages 0 to 2” and “ages 3 and higher” is a target period, estimation can be performed with high accuracy and without being affected by a difference in the numbers of words. In addition, since words recorded in the CVD are words to be picked up from age 0 to around age 3, in the case of “ages 0 to 2”, coverage is high to begin with, and difficulty estimation can be performed solely based on conformance with the CVD.

Furthermore, while a case where which of “ages 0 to 2” and “ages 3 and higher” is a target period is estimated has been described as an example of the first-stage difficulty estimation, the present invention is not limited thereto and an estimation may be performed by applying more detailed class separation in both “ages 0 to 2” and “ages 3 and higher”.

In addition, class separation may be performed using an average age in months of a “beginning period of utterance”, a “period of vocabulary spurt”, and a “beginning period of utterance of 2-word sentences” to be used to perform the first-stage difficulty estimation. For example, the “beginning period of utterance” is 10 months old, the “period of vocabulary spurt” is 20 months old, and the “beginning period of utterance of 2-word sentences” is 24 months old.

Furthermore, difficulty estimation may be performed in a plurality of stages such as three or more stages.

In addition, while a case where an acquisition period is estimated and used has been described as an example with respect to words not contained in the CVD, the present invention is not limited thereto. For example, words not contained in the CVD may be either ignored or assigned information (for example, NULL) indicating that the word is not contained so as to prevent the word from being used in difficulty estimation.

Furthermore, while “a one book one story format” is considered as texts of picture books in the embodiment described above, when numbers related to the number of differences in words are not used as a feature amount, formats other than “a one book one story format” may also be considered an object.

In addition, while a case where a difficulty estimation model is learned using a ranking SVM or a ranking forest has been described as an example in the embodiment described above, the present invention is not limited thereto and, for example, a difficulty estimation model may be learned using other methods (a neural network, the k-nearest neighbors algorithm, Bayesian classification, or the like).

Reference Signs List

| | |
|---|---|
| 8 | Text database |
| 10, 210 | Input unit |
| 20, 220 | Computing unit |
| 28, 229 | Word database |
| 30, 230 | Feature amount extracting unit |
| 32 | Difficulty estimation model generating unit |
| 40, 240 | Difficulty estimation model |
| 100 | Difficulty estimation model learning device |
| 200 | Difficulty estimation device |
| 228 | Preprocessing unit |
| 232 | Difficulty estimating unit |
| 250 | Output unit |

1. A difficulty estimation device, comprising:
a feature amount extractor configured to extract, using an acquisition period which is obtained in advance for each word and in which an infant acquires the word, a feature amount including an acquisition period of a word included in an input text from the text; and
a difficulty estimator configured to estimate difficulty or a target period of the text based on:
the feature amount of the text, extracted by the feature amount extracting unit, and
a difficulty estimation model obtained in advance for estimating difficulty or the target period of the text, wherein the target period is associated with a targeted age of a reader.

2. The difficulty estimation device according to claim 1, wherein the feature amount extractor is configured to extract, for each category related to words, the feature amount including the acquisition period of the word which is included in the text and which belongs to the category.

3. The difficulty estimation device according to claim 2, wherein the feature amount extractor is configured to extract, for each category related to words, the feature amount including a ratio of a word which is included in the text and which belongs to the category.

4. The difficulty estimation device according to claim 3, wherein the feature amount extractor is configured to estimate, with respect to a word of which the acquisition period has not been yet obtained among words included in the input text, the acquisition period in which an infant acquires the word using an appearance frequency of each word having been obtained in advance for each word, and wherein the feature amount extractor is further configured to, using the estimated acquisition period, extract a feature amount including the acquisition period of the word included in the input text from the text.

5. The difficulty estimation device according to claim 1, the device further comprising:
the feature amount extractor configured to extract, using familiarity or imageability of each word having been obtained in advance for each word,
the feature amount including familiarity or imageability of the word included in the n input text from the text.

6. The difficulty estimation device according to any one of claims 5, wherein the feature amount extractor is configured to extract, using familiarity or imageability of each word having been obtained in advance for each word and an acquisition period which is obtained in advance for each word and in which an infant acquires the word,
the feature amount including familiarity or imageability of the word and the acquisition period of the word included in the input text from the text.

7. The difficulty estimation device of claim 1, the device further comprising:
the feature amount extractor configured to extract, from an input text, a feature amount that includes at least one of the number of arguments of a declinable word and a type of a declinable word that is included in the text.

8. The difficulty estimation device according to claim 7, wherein the feature amount extractor is configured to extract, as the type of the declinable word, whether a verb included in the text is an intransitive verb or a transitive verb.

9. The difficulty estimation device according to claim 8, wherein the feature amount extractor is configured to extract, as the type of the declinable word, whether or not a verb included in the text is a verb that takes a particle other than the particle [symbol] (ga) and the particle [symbol] (wo).

10. The difficulty estimation device of claim 1, the device further comprising:
the feature amount extractor configured to extract, for each category related to words, the feature amount that includes a ratio of nouns and/or declinable words which belong to the category and which are included in an input text from the text.

11. The difficulty estimation device of claim 1, the device comprising:
the feature amount extractor configured to extractfrom an input text, using one or more types of basic word sets obtained in advance, with respect to each of the one or more types of basic word sets, the feature amount including a ratio of words included in the basic word set and/or a ratio of words not included in the basic word set among words included in the text.

12. The difficulty estimation device according to claim 1, wherein the difficulty estimator is configured to estimate any of classes related to difficulty and a target period, and wherein the difficulty estimator is configured to estimate difficulty or a target period of the text in the estimated class.

13. A difficulty estimation method, the method comprising:
extracting, using an acquisition period which is obtained in advance for each word and in which an infant acquires the word, a feature amount including an acquisition period of a word included in an input text from the text; and
estimating difficulty or a target period of the text based on the feature amount of the text, extracted by the feature amount extractor, and a difficulty estimation model obtained in advance for estimating difficulty or a target period of the text.

14. The difficulty estimation method of claim 13, the method further comprising:
extracting, using familiarity or imageability of each word which is obtained in advance for each word, the feature amount including familiarity of the word included in the input text from the text.

15. The difficulty estimation method of claim 13, the method further comprising:
extracting, from the input text, the feature amount that includes at least one of the number of arguments of a declinable word and a type of a declinable word that is included in the text.

16. The difficulty estimation method of claim 13, comprising:
extracting, for each category related to words, the feature amount that includes a ratio of nouns and/or declinable words which belong to the category and which are included in the input text from the text.

17. The difficulty estimation method of claim 13, the method further comprising:
extracting from an input text, using one or more types of basic word sets obtained in advance, with respect to each of the one or more types of basic word sets, the feature amount including a ratio of words included in the basic word set and/or a ratio of words not included in the basic word set among words included in the text.

18. A difficulty estimation model learning device, comprising:
a feature amount extractor configured to extract, using an acquisition period which is obtained in advance for each word and in which an infant acquires the word, a feature amount including an acquisition period of a word included in each of texts to which difficulty or a target period has been added from the text; and
a difficulty estimation model generator configured to learn a difficulty estimation model for estimating difficulty or a target period of the text based on the feature amount extracted with respect to each of the texts by the feature amount extracting unit and the difficulty or the target period added to each of the texts, wherein the target period is associated with a targeted age of a reader of the text.

19. The difficulty estimation model learning device of claim 18, the device further comprising:
the feature amount extractor configured to extract, using familiarity or imageability of each word which is obtained in advance for each word, the feature amount including familiarity of the word included in each of texts to which difficulty or the target period has been added from the text.

20. The difficulty estimation model learning device of claim 18, the device further comprising:
the feature amount extracting unit which extracts, from each of texts to which difficulty or the target period has been added, the feature amount that includes at least one of the number of arguments of a declinable word and a type of a declinable word that is included in the text.

21-28. (canceled)
